(19) United States
(12) Patent Application Publication
(10) Pub. No.: US 2017/0336642 A1
(43) Pub. Date: Nov. 23, 2017

(54) HEAD-UP DISPLAY WITH ADJUSTABLE VIEWING WINDOW

(71) Applicant: VALEO COMFORT AND DRIVING ASSISTANCE, Créteil (FR)

(72) Inventor: Pierre Mermillod, Créteil (FR)

(73) Assignee: VALEO COMFORT AND DRIVING ASSISTANCE, Créteil (FR)

(21) Appl. No.: 15/532,662

(22) PCT Filed: Dec. 4, 2015
(86) PCT No.: PCT/FR2015/053336

§ 371 Date: Jun. 2, 2017

(30) Foreign Application Priority Data
Dec. 5, 2014 (FR) 1402789

(51) Int. Cl. G02B 27/01; G06T 3/20

(52) U.S. Cl. CPC G02B 27/0179; G06T 3/20; G02B 27/0101; G02B 2027/0181; G02B 2027/0187

(57) ABSTRACT

The invention relates to an image generator, particularly for head-up display with an adjustable viewing window, particularly for motor vehicle. The image generator is configured to display an image (7) on a display surface (2). The image (7) is for a semi-reflective optical element (3) arranged spaced apart from the image generator and configured to form, on a first side of the optical element (3), a virtual image (4) of the image (7). The virtual image (4) is visible from a viewing window (5) located on a second side of the optical element (4). The image generator is configured to display the image (7) on only one part of the display surface (2) and comprises a means for moving the image (7) on the display surface (2). The invention also relates to a head-up display (1) with an adjustable viewing window, said display comprising such an image generator.

The present invention relates to an image generator, particularly for a head-up display with an adjustable viewing window, particularly for a motor vehicle. The invention also relates to a head-up display with an adjustable viewing window.

The function of head-up displays is generally to superimpose information to assist with piloting, navigation or the achievement of the mission, in the field of vision of an aircraft pilot, for example. Thus, this allows the pilot to monitor the environment thereof at the same time as reading information provided by the on-board instruments thereof. Today, these instruments are generally used in cars.

Such devices comprise an image generator and a semi-reflective optical element configured to form a virtual image of the image of the generator. The virtual image is superimposed on the environment in the field of vision of the driver or of the pilot. It is also possible to use the windshield of the vehicle as a semi-reflective optical element in order to form the virtual image. The technical features of such a device relate in particular to the position of the optical element with respect to the road and to the driver, and to the angle of incidence of the image on the optical element, in order to particularly prevent problems of distortion.

The image generators known in cars comprise one or more light sources and a pixel matrix which receives the light beam from the sources. The matrix transmits or reflects the light beam by printing an image which is formed thanks to the pixels. Each pixel is controlled individually, and can either have a so-called “open” position, in which the incident light contributes to the image, or a so-called “closed” position, in which the incident light does not contribute to the displayed image. Thus, an image is composed according to the open pixels. It is also possible to use laser scanning as a means of forming images.

There are various types of matrices, particularly the TFT (Thin Film Transistor)-type transistor matrices, which operate with light transmission, i.e. the light beam from the sources passes through the matrix which is arranged between the light source and the optical element. Also known are the LCOS (Liquid Crystal on Silicon)-type matrices, and the DMD (Digital Micro-Mirror Device)-type micro-mirror matrices, which operate by reflecting the light beam towards the optical element.

An observer sees the virtual image through the optical element, the virtual image appearing on one side of the optical element, whereas the observer is located on the other side of the optical element. Moreover, the eyes of the observer must be positioned in a viewing window, commonly called an “eyebox”. The position of the viewing window is defined by the position of the virtual image with respect to the optical element. Thus, outside this viewing window, it is not possible to see the virtual image.

Yet, in some cases, it can be necessary to adjust the positioning of the viewing window in order to adapt it to an observer. In the known current devices, the semi-reflective optical element is acted upon in order to move it. Indeed, by changing, for example, the inclination of the optical element, the virtual image moves, and consequently the viewing window. For this purpose, it is necessary to use mechanical means which act upon the optical element. Consequently, firstly the display is expensive to manufacture, and secondly, it is bulkier due to the mechanical means. Furthermore, the inclination of the semi-reflective element only allows for moving the viewing window in a vertical manner.

Therefore, the aim of the invention is to improve the situation and to obtain a head-up display, the viewing window of which can be adjusted in all directions and in a simple manner.

For this purpose, the invention relates to an image generator, particularly for a head-up display with an adjustable viewing window, particularly for a motor vehicle, the image generator being configured to display an image on a display surface, the image being intended for a semi-reflective optical element arranged at a distance from the image generator and configured to form, on a first side of the optical element, a virtual image of the image, the virtual image being visible from a viewing window located on a second side of the optical element.

The image generator is characterized in that it is configured to display the image on only a part of the display surface and includes means for moving the image on the display surface.

Thus, thanks to the image generator, it is sufficient to move the image on the display surface in order to move the viewing window of the head-up display, without needing to use mechanical means acting upon the optical element, for example. As a result, the display is less expensive to manufacture and more compact. Furthermore, the display is more reliable since it does not include mechanical means which risk becoming worn or failing.

According to various embodiments of the invention, which can be taken together or separately:

the movement of the image on the display surface along a first axis allows the viewing window to be moved vertically,
the movement of the image on the display surface along a second axis perpendicular to the first axis allows the viewing window to be moved horizontally,
the display comprises means for detecting the position of an observer providing the movement means with a signal,
the image generator comprises at least one light source suitable for emitting a light beam, and a pixel matrix configured to form the virtual image from the light beam,
the pixel matrix is a matrix of thin film transistors,
the pixel matrix is a matrix of micro-mirrors,
the image generator is configured to form a substantially rectangular image.

The invention also relates to a head-up display with an adjustable viewing window, particularly for a motor vehicle, including an optical element and comprising such an image generator.

According to various embodiments of the invention, which can be taken together or separately:
the optical element is a semi-reflective plate,
the optical element is a part of a vehicle windshield,
the optical element has a curvature such as to carry at least partially the optical power necessary for the formation of the virtual image,
the display comprises at least one mirror arranged such as to reflect the image from the generator image towards the optical element.

The invention will be better understood in light of the following description which is only given indicatively and without the intention of limiting the invention, in conjunction with the following figures:

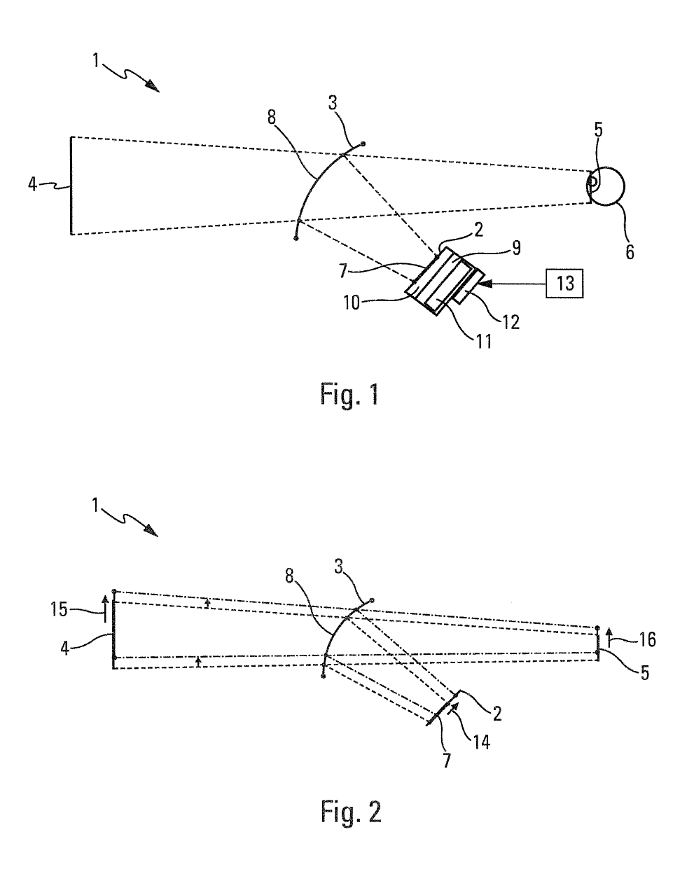

FIG. 1 schematically illustrates an embodiment of a display provided with an image generator according to the invention,

FIG. 2 schematically illustrates the movement of the viewing window of the display of FIG. 1.

FIG. 1 shows the operation of a head-up display 1, for example of a motor vehicle. The display 1 comprises an image generator 9, configured to display an image 7 on a display surface 2. The image generator 9 comprises, for example, at least one light source 11 suitable for emitting a light beam, and a pixel matrix 10 configured to form the image 7 from the light beam. The light sources 11 are, for example, light emitting diodes, which are positioned in a part of the generator. The generator includes the pixel matrix 10, for example of TFT type, on the output face thereof. Thus, the diodes emit a beam towards the matrix which prints an image 7 transmissively on the display surface 2 of the image generator 9. The image generator 9 is, for example, configured to form a substantially rectangular image.

The display 1 also comprises a semi-reflective optical element 3 arranged at a distance from the image generator 9 and configured to show, on a first side of the optical element 3, a virtual image 4 of the image 7 of the display surface 2. The virtual image 4 can be seen by an observer 6 if the latter looks at the optical element 3 while being placed on the other side of the optical element 3. As shown in FIG. 1, the image 7 is reflected in the direction of the observer 6, by a part 8 of the surface of the optical element 3. The path of the image 7 is shown in dashed line. The optical element 3 thus forms a virtual image 4 of the image 7, which appears on the first side at a certain distance from the optical element 3.

However, not only must the observer 6 be on the second side of the optical element 3, but the latter furthermore sees the virtual image only if the eyes thereof are inside a viewing window 5 located on the second side of the optical element 3. The dimensions of the viewing window 5 are defined particularly by the size and the shape of the part 8 of the surface of the optical element 3 which reflects the image 7.

The optical element 3 thus allows an observer 6 both to see the virtual image 4 and to see through the optical element 3. For an observer who is located on the second side of the optical element 3, the virtual image 4 is superimposed in the field of vision thereof on the environment seen through the optical element 3. In this case, the optical element 3 is a semi-reflective plate.

In another embodiment of the display, used in a vehicle and which is not shown in the figures, a part of the windshield is used as a semi-reflective optical element. To this end, the rest of the display is arranged in the dash such as to be able to use the windshield. In this case, a mirror is generally arranged on the optical path of the image such as to reflect it towards the part of the windshield.

Furthermore, the optical element 3 has a curvature in order to carry an optical power such as to show the virtual image 4 at a certain distance from the optical element 3 with a certain magnification, and thus be suitably superimposed on the environment appearing in the field of vision of the observer 6. The optical power is a physical characteristic, which determines the capacity of an optical system to converge or diverge light. It is equal to the ratio between the angle at which the eye sees the image output from the system and the size of the object. The optical power thus makes it possible to set the size of the virtual image 4.

According to the invention, the image generator 9 is configured to display the image 7 on only a part of the display surface 2. In other words, there is always another part of the display surface that is not used to display the image 7. This other part preferably surrounds the displayed image in order to be able to move the image along several axes and thus to set the position of the viewing window 5 in several directions.

The image generator 9 further includes means 12 for moving the image 7 on the display surface 2. The movement means 12 are, for example, a control unit of the image generator 9, which can be actuated by the observer 6 by means of buttons arranged on the generator or elsewhere.

In an alternative embodiment, the display 1 comprises means 13 for detecting the position of the observer 6. The detection means 13 provide the movement means 12 with a signal corresponding to the position of the observer, in order to set the viewing window 5 by moving the image 7. The detection means 13 observe, for example, the position of the eyes of the observer in order to adjust the viewing window 5.

FIG. 2 illustrates an example of vertical adjustment of the viewing window 5. The image 7 is moved on the display surface along a first axis shown by an arrow 14. The reflective part 8 of the optical element 3 is consequently offset, which leads to a movement of the virtual image 4 in the upward direction, and which is shown by another arrow 15. Thus, the viewing window 5 rises as shown by a third arrow 16.

Preferably, the moving means 12 of the generator 9 are configured to also move the image 7 on the display surface 2 along a second axis substantially perpendicular to the first axis. Thus, it is also possible to horizontally set the position of the viewing window 5.

1. An image generator for a head-up display with an adjustable viewing window for a motor vehicle, wherein:
the image generator configured to display an image on a display surface,
the image is for a semi-reflective optical element arranged at a distance from the image generator and configured to form, on a first side of the optical element, a virtual image of the image, the virtual image being visible from a viewing window located on a second side of the optical element, and
the image generator is configured to display the image on only a part of the display surface and includes means for moving the image on the display surface.

2. The image generator as claimed in claim 1, wherein the movement of the image on the display surface along a first axis allows the viewing window to be moved vertically.

3. The image generator as claimed in claim 2, wherein the movement of the image on the display surface along a second axis perpendicular to the first axis allows the viewing window to be moved horizontally.

4. The image generator as claimed in claim 1, further comprising means for detecting the position of an observer providing the movement means with a signal.

5. The image generator as claimed in claim 1, wherein the image generator comprises at least one light source suitable for emitting a light beam, and a pixel matrix configured to form the virtual image from the light beam.

6. The image generator as claimed in claim 5, wherein the pixel matrix is a matrix of thin film transistors.

7. A head-up display with an adjustable viewing window including an optical element, comprising an image generator as claimed in claim 1.

8. The display as claimed in claim 7, wherein the optical element is a semi-reflective plate.

9. The display as claimed in claim 7, wherein the optical element is a part of a vehicle windshield.

10. The device as claimed in claim 7, wherein the optical element has a curvature such as to carry at least partially the optical power necessary for the formation of the virtual image.
